(19) United States
(12) Patent Application Publication
(10) Pub. No.: US 2007/0190661 A1
(43) Pub. Date: Aug. 16, 2007

(54) Method and device for recording microscopic images

(76) Inventors: Frank Theodor Gudermann, Gutersloh (DE); Marc Sturz, Bielefeld (DE)

Correspondence Address: VENABLE LLP, P.O. BOX 34385, WASHINGTON, DC, 20043-9998, US

(21) Appl. No.: 10/596,746

(22) PCT Filed: Dec. 21, 2004
(86) PCT No.: PCT/EP04/14542

§ 371 Date: Apr. 16, 2007

(30) Foreign Application Priority Data
Dec. 22, 2003 (DE) 103 61 073.1

(51) Int. Cl. G01N 21/00

(52) U.S. Cl. 436/164; 436/172

(57) ABSTRACT

The invention relates to a method and a device for recording high-resolution microscopic images of particles or organisms suspended in a liquid, wherein the suspension is introduced into a measuring cell, especially a flow cuvette, and the image of the suspension is recorded by an optical sensor, and wherein the optical sensor and the measuring cell are moved relative to one another while the content of the measuring cell is imaged completely or in part.

The invention relates to the generation of microscopic images by scanning a measuring cell with an optical sensor. Preferably, the measuring cell is a flow cuvette. For simplicity, only the latter will be mentioned in the following.

The Innovatis AG develops, produces and sells devices for particle and cell analysis. For analyzing cell density, for classification into living and dead cells and for determining the diameter and geometry of objects, images of particles or cells are recorded. During the analysis, the objects are in suspension in an optically suitable cuvette.

### PRIOR ART

The automatic systems for examining the density, viability and diameter of cell-containing suspensions of biological origin which have been previously on the market are based on the measurement of electric resistance or electric capacity, laser diffractometry or optical image analysis.

The evaluation of objects by means of optical image recording and digital image analysis has been realized by using a microscope to date, wherein a microscope lens system is used for the magnification of objects which in part have a size of only a few micrometers. The thus generated image is recorded with a digital camera and evaluated by special computer programs.

As an example of the conventionally employed automatic method, the Cedex System (Innovatis AG) may be mentioned. This system works with an adapted microscope lens system which enables cell densities and viabilities of suspension cells to be determined. According to the same principle, analysis of the cell culture is performed by the subsequently developed Vi-CELL system (Beckman Coulter Inc.). The basic method is limited by three parameters which do not allow detection below a certain object size:

1. Depth of Field

To be able to record objects in a flow cuvette by means of a microscope lens system, the objects must be imaged with sufficient definition throughout the height of the cuvette.

2. Height of the Cuvette

The cuvette must be sufficiently large for enough objects to be recorded for statistic significance, and at the same time, it must be sufficiently small to enable some depth of field throughout the range of cuvette height.

3. Number of Objects

By the method of image recording, it is not possible to detect below an object density of 5×10⁴ objects per ml of suspension without leaving the range of statistic significance.

Since the depth of field is proportional to 1/NA² and the optical resolution is proportional to 1/NA (where NA=numerical aperture), when the resolution is reduced in order to obtain images with more details, the depth of field will decrease with the square thereof.

In the conventionally applied methods, the measuring cuvette is filled completely with the sample material, and the microscope lens system is used to set a depth of field which extends throughout the range of cuvette height. To reach the range of statistic significance, correspondingly many images of the sample must be recorded by successively filling the cuvette.

EP 1 329 706 A1 describes a method in which the sample extends throughout the cuvette height. The resolution of the system and thus the minimum required size of the particles to be analyzed is limited by the depth of field which is required for recording a high-definition image of the sample throughout the cuvette height. The digital image recording is effected by means of a camera rather than a scanner. This patent from the year 2003 describes the functioning of the above mentioned Cedex system, which was published as early as 1997 (Animal Cell Technology, Proceedings of the 14th Meeting of ESACT, Kluwer Academic Publishers, 1997, pages 301-305).

In DE 41 16 313 C2, the sedimentation of several samples is simultaneously performed in a centrifuge. The object of the method is the determination of elastomechanical properties of pellets obtained from suspensions and emulsions.

U.S. Pat. No. 6,141,624 A describes how a sufficient amount of sample for the detection of different particles by means of a flow cuvette can be automatically provided.

Object

The object of the present invention is, in particular, to provide a method and a device for recording images in the microscopic range by which a high optical resolution can be achieved. Further objects can be seen from the overall presented solutions and advantages.

Invention

The features of the invention are represented in the independent claims. Further features of the invention or advantageous further developments thereof are mentioned in the dependent claims and in the description.

In particular, the combination of the following methods is provided according to the invention:
introducing a sample in a measuring cell, especially a flow cuvette;
sedimentation of the sample;
digital image recording by means of a scanner;
analyzing the particles in the sample by evaluating the recorded image.

It is thereby distinguished from the conventional methods mentioned.

Instead of a microscope lens system with an autofocus mechanism and electronics and a digital camera (optionally with a frame grabber), a scanner is used which can replace all the functions of the above mentioned conventional components, in particular.

By means of the scanner, more image data material can be recorded in a short period of time as compared to the conventional method. If the sample chamber is correspondingly large, an enormous time gain is achieved which enables the objects to be allowed to settle and to act in a smaller focus range and thus increase the optical resolution. With this method, much smaller objects or particles can be analyzed then.

### BRIEF DESCRIPTION OF THE FIGURES

FIG. 1: Schematic representation of the conventional image recording method

FIG. 2: Schematic representation of the scanner image recording method

FIG. 3: Schematic representation of the transmitted light method

FIG. 4: Schematic representation of the dark field method

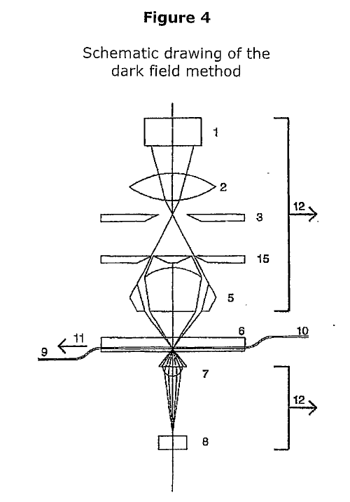

FIG. 5: Schematic representation of the fluorescence method

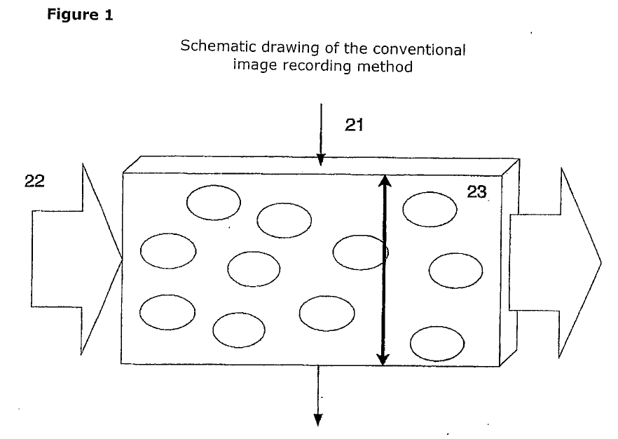

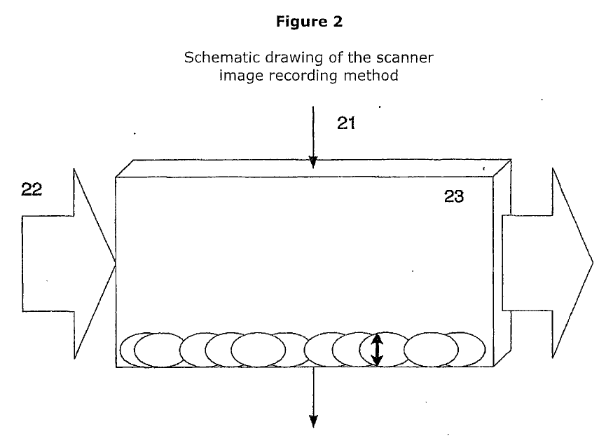

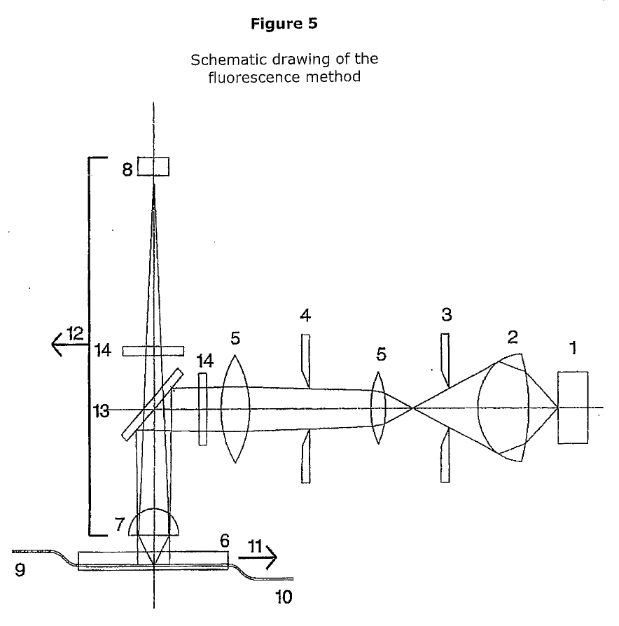

FIGS. 1 and 2 schematically show the conventional and novel image recording methods. Both Figures respectively show a flow cuvette (23) with an optical axis (21) and direction of flow (22). The vertical double-headed arrow indicates the depth of field required for optimum image recording.

Since there is a reciprocal quadratic relationship, the higher optical resolution is selected at a lower depth of field in the novel method in order to record images of the sample material in the flow cuvette. In the conventional method, this could be performed only in an unreasonably long period of time.

The image data material provided by the device according to the invention can subsequently be subjected to image data analysis.

The essential advantage of the device is the fact that a high optical resolution of a suspension of cells or particles is achieved. This is achieved, inter alia, by allowing the objects to settle onto an optical plane while the sample volume is high. The settling of the objects can be effected by sedimentation of other suitable methods.

The different techniques for accumulating objects within the measuring cuvette may be:
adhesion
repulsion
electric action
magnetic action
gravity
centrifugation
buoyancy
immobilization
coupling
   as well as combinations of these methods.

The device is suitable for microscopic recordings in incident light, transmitted light, fluorescence, phase contrast, dark field and light in the visible and non-visible regions as well as all possible combinations thereof. Further, it may include the further contrast methods corresponding to the current prior art.

The samples to be examined may be particle solutions or cell material of biological origin which may be examined in both unstained and stained forms.

A determination of the concentration and viability of cell-containing biological samples of a culture suspension as well as apoptotic behavior, product concentration and analysis of intracellular compartments and metabolic processes is performed.

In addition, the following parameters are determined: diameters of individual objects, aggregation rate, geometry, number of objects counted and deviation from the mean value as well as surface texture and morphology.

The resulting data and parameters are established from the recorded image data by means of a computer method.

The measurement is based on a method (microscopic methods and others) in which the sample containing particles/cells flows through a cuvette (flow cuvette). With an optical line or area sensor, digital images of the sample in the cuvette are recorded and then evaluated by a method of optical image analysis.

The basic idea is to construct a device (scanner) in such a way as to yield the corresponding resolution required for high-quality imaging even on a micrometer scale. This is achieved by an altered lens system, adapted autofocus methods and a modified mechanism. In this case, the image recording is effected either by moving the scanner unit relative to the particle sample, or by moving the particle sample relative to the scanner unit. Thus, the cuvette is provided vertically in the optical path.

The read-out rate of the optical sensor is synchronized with the traversing speed to produce one or more images.

In the following, a possible course of the method is listed and explained:
Introducing the sample in the measuring cuvette
Settling of the objects of the sample in the solution
   Accumulation of the objects in one optical plane. In an exemplary manner, this process will be referred to as “sedimentation” in the following.
Scanning
   Digital image recording taking into account a sufficient volume of the sample to achieve a statistically representative result with one image (see also “Prior Art” Section).
Analysis of the image data material
   Especially adapted analysis of the image data material for establishing a result.
Display and export of the analytical data
   User-friendly presentation of the result data as numerical values as well as graphic display.

With this method, it is possible to analyze individual objects. When cell material of biological origin is analyzed, analysis of morphology, surface texture etc. may be effected.

The benefit gained by integrating a scanner unit for optical image acquisition is given by the enlargement of the detection range. Due to its resolution, a corresponding scanner lens system can analyze significantly smaller object diameters than is possible with the current state of the art. Additional pieces of information about the structure and morphology of the objects can be obtained.

By the method of sedimentation, it has now become possible for the first time to record and analyze all objects of a sample at once.

Since a higher number of objects per unit volume can be evaluated by suitably selecting the measuring cuvette, the method of the present application requires a smaller sample volume than is usual in the systems of current design.

### DESCRIPTION OF EXAMPLES

The method described is based on microscopic records generated under a variety of conditions: incident light, transmitted light, fluorescent light, phase contrast, further contrast methods, dark field and light in the visible and non-visible regions as well as all possible combinations thereof.

As an example, several microscopic recording methods are described in the following. For realizing the method, these and other light-providing methods can be combined.

The sample solution/suspension to be examined is contained in a cuvette as the measuring cell. After the cell material has been introduced, it is waited until the objects to be observed have sedimented onto the cuvette ground. Then, an image is recorded. During the recording of the image, the cuvette and scanner move relative to one another. That is, either the particle sample moves relative to the resting scanner unit, or the scanner unit moves relative to the resting particle sample. The region of the cuvette which is recorded thereby is variable.

### Example (a)

### Transmitted Light Method

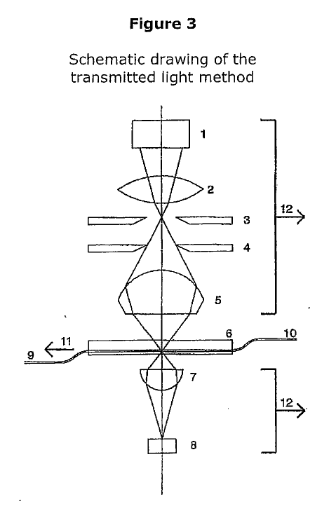

An Example of the invention for transmitted light records is represented in FIG. 3 and will be described in the following.

The optical sensor 8 is situated on one side of the cuvette 6, the light source 1 on the opposite side. For concentrating the light beams and for magnifying the image, an illumination lens system 2, 3, 4, 5 and objective 7 are brought into the optical path. The illumination lens system consists of a collector lens 2, radiant field screen 3, condensor 4 and condensor lens 5. In addition, several filters may be brought into the optical path. For supplying the cuvette 6 with the sample solution, the latter is supplied through the inlet capillary 9 and discharged through the outlet capillary 10. The image recording is effected either by moving the scanner unit relative to the resting particle sample 11, or by moving the particle sample relative to the resting scanner unit 12, which comprises the components 1-5 and 7-8.

### Example (b)

### Dark Field Method

The optical sensor 8 is situated on one side of the cuvette 6, the light source 1 on the opposite side. For concentrating the light beams and for magnifying the image, an illumination lens system consisting of the collector lens 2, radiant field screen 3 and occulting disk 15, condensor lens 5 and objective 7 are brought into the optical path. In addition, several filters may be brought into the optical path. For supplying the cuvette 6 with the sample solution, the latter is supplied through the inlet capillary 9 and discharged through the outlet capillary 10. The image recording is effected either by moving the scanner unit relative to the resting particle sample 11, or by moving the particle sample relative to the resting scanner unit 12, which comprises the components 1-5 and 7-8 in this case too.

### Example (c)

### Fluorescence Method

For recording fluorescence images in the incident light method, the light coming from the sample is guided to the optical sensor after having passed the beam splitter 3 which couples the light into the optical path for illuminating the sample.

The optical sensor 8 is situated on an optical axis with the cuvette 6. The beams from the light source 1 are concentrated and collimated by means of an illumination lens system before illuminating the sample in the cuvette 6 through the beam splitter 13 and the objective 4. The illumination lens system consists of the collector lens 2 and radiant field screen 3 as well as further lenses 5 and another screen 4. In addition, appropriate filters 14 may be brought into the optical path. For supplying the cuvette 6 with the sample solution, the latter is supplied through the inlet capillary 9 and discharged through the outlet capillary 10. The image recording is effected either by moving the scanner unit relative to the resting particle sample 11, or by moving the particle sample relative to the resting scanner unit 12.

### Example (d)

The number and viability of small particles, e.g., suspended blood cells or yeasts, are to be determined in a sample. The sample volume is about 500 μl. For determining viability, the sample is stained.

The sample is placed into the cuvette, where the particles in the sample sediment for some time. The sedimentation time to be observed depends on the respective sedimentation behavior of the particles in the respective suspension, i.e., on the density of the particles and viscosity of the suspension, the cuvette height as well as the depth of field of the image recording lens system.

After elapse of the sedimentation time, a representative proportion of the particles are on the cuvette ground or at a height above it which is admissible due to the optical properties of the system, so that it is possible to image all particles with sufficient definition. In addition, at this time, the particle movements in the direction of flow and in the direction of sedimentation have subsided to the extent that undistorted image recording can be effected by means of a line sensor (scanner).

Now, the digital image recording of the whole sample is effected in one step. The thus obtained image data are processed digitally and analyzed with known methods. As a result, the particle concentration and viability as well as further characteristics of the particles, such as their diameters, are obtained.

### LIST OF REFERENCE SYMBOLS

1 light source
2 collector lens
3 radiant field screen
4 condensor
5 condensor lens
6 cuvette
7 objective
8 sensor
9 inlet capillary
10 outlet capillary
11 particle sample
12 scanner unit
13 beam splitter
14 filter
15 occulting disk
21 axis
22 direction of flow
23 flow cuvette

1. A method for recording microscopic images with high optical resolution of particles or organisms suspended in a liquid, comprising introducing the suspension in a measuring cell, and recording the image of the suspension by an optical sensor, wherein the optical sensor and measuring cell are moving relative to one another while the contents of the measuring cell are imaged.

2. The method according to claim 1, characterized in that said sensor is moving along the measuring cell.

3. The method according to claim 1, characterized in that said measuring cell is moving along the sensor.

4. The method according to claim 1, characterized in that said measuring cell is imaged onto said optical sensor by the movement of optical elements.

5. The method according to claim 1, further comprising allowing the particles to sink onto the ground of the measuring cell or into a region above the ground, wherein only part of the measuring cell contains the particles or organisms to be examined, imaging the ground or the region above with a high optical resolution, and covering the ground or the region above by the optical sensor.

6. The method according to claim 1, further comprising allowing the particles to rise to an upper limiting surface of the measuring cell or into a region below the upper limiting surface, wherein only part of the measuring cell contains the particles or organisms to be examined, imaging the upper limiting surface or the region below with a high optical resolution, and covering the upper limiting surface or the region below by the optical sensor.

7. The method according to claim 5, wherein said sinking or rising of the objects within the cuvette can be effected by one or more of the following: biological techniques, physical techniques, chemical techniques, sedimentation, and buoyancy.

8. The method according to claim 1, further comprising providing transmitted light illumination, wherein a light source is situated on one side of the measuring cell, and the optical sensor and an objective sensor are located on the opposite side of the measuring cell.

9. The method according to claim 1 further comprising providing incident light illumination by situating a, light source, an objective, and the optical sensor on the same side of the measuring cell.

10. The method according to claim 8, wherein the transmitted light illumination is bright field illumination.

11. The method according to claim 8, wherein the transmitted light illumination is dark field illumination.

12. The method according to claim 8, wherein the transmitted light illumination is phase contrast illumination.

13. The method according to claim 9, wherein the incident light illumination is fluorescence illumination.

14. The method according to claim 9, further comprising illuminating the objects in the measuring cell with a defined spectral intensity distribution of the incident light by a suitable light source or the insertion of one or more suitable filters.

15. The method according to claim 9 further comprising illuminating the optical sensor with a defined spectral intensity distribution of the incident light by a suitable light source or the insertion of one or more suitable filters enables the optical sensor to be illuminated with a defined spectral intensity distribution of the incident light.

16. The method according to claim 8, wherein the illumination is one or more of the following: bright field, dark field, and phase contrast illumination.

17. The method according to claim 1, further comprising admixing the suspension with stains prior to the introducing step.

18. The method according to claim 14, further comprising changing the one or more filters automatically or manually.

19. (canceled)

20. A device for recording microscopic images with high optical resolution of particles or organisms suspended in a liquid, wherein the suspension is introduced in a measuring cell, and the image is recorded by an optical sensor, and further wherein the optical sensor and measuring cell are movable relative to one another and the contents of the measuring cell can be imaged.

21. The device according to claim 20, wherein a light source is situated on one side of the measuring cell, and the an objective sensor and the optical sensor are located on the other, opposite side of the measuring cell.

22. The device according to claim 20 wherein a light source is situated on the same side of the measuring cell as an objective sensor, and the optical sensor.

23. The method according to claim 1, wherein said measuring cell is a flowing cuvette.

24. The device according to claim 20, wherein said measuring cell is a flowing cuvette.

25. The method according the claim 8, further comprising providing a screen and lens system on the same side of the measuring cell as the light source.

26. The method of claim 8 wherein the screen and lens system is a condenser.

27. The method of claim 9, wherein the illumination is fluorescence illumination, spectral intensity distribution of the incident light, or a combination thereof.
